(19) United States
(12) Patent Application Publication
(10) Pub. No.: US 2008/0314207 A1
(43) Pub. Date: Dec. 25, 2008

(54) Angle Nut Runner

(76) Inventor: Koji Tatsuno, Osaka (JP)

Correspondence Address: WENDEROTH, LIND & PONACK, L.L.P., 2033 K STREET, N.W. SUITE 800, WASHINGTON, DC, 20006, US

(21) Appl. No.: 11/658,673

(22) PCT Filed: Aug. 11, 2005
(86) PCT No.: PCT/JP05/14754

§ 371 Date: Jan. 29, 2007

(30) Foreign Application Priority Data
Aug. 18, 2004 (JP) 2004-238082

(51) Int. Cl. B25B 23/14; B25B 17/00

(52) U.S. Cl. 81/467; 81/57

(57) ABSTRACT

Provide an angle nut runner capable of accurately measuring a genuine tightening force.

In the angle nut runner having an output shaft 2 pivotally supported approximately perpendicular to the rotating shaft 1 of the drive source, a strain measuring mechanism 3 for measuring a strain generated in the output shaft 2 is disposed on the output shaft 2.

### TECHNICAL FIELD

The present invention concerns a nut runner for performing tightening work and loosening work of bolts & nuts and screws, more specifically an angle nut runner having an output shaft pivotally supported approximately perpendicular to the rotating shaft of the drive source.

### BACKGROUND ART

Conventionally, nut runner is widely used as a tool for performing tightening work and loosening work of bolts & nuts and screws.

And, nut runners are roughly classified into straight nut runners having an output shaft pivotally supported on a straight line against the rotating shaft of the drive source, and angle nut runners having an output shaft pivotally supported approximately perpendicular to the rotating shaft 1 of the drive source M, applied to tightening work and loosening work at comparatively narrow points where a straight nut runner cannot be used, as shown in FIG. 3.

By the way, as greater importance is attached to quality control of industrial products, in recent years, a production control system has come to be adopted which consists in automatically measuring-recording the number of tightened pieces and tightening force of bolts & nuts and screws, and feedback the results of measurement in real time to the production of industrial products.

And, in an angle nut runner indicated in FIG. 3, a torque transducer TM for performing measurement of tightening force used to be disposed at about the middle position of the nut runner body B, to be available for use for the above-described production control system.

However, in the case where the torque transducer TM for performing measurement of tightening force is disposed at about the middle position of the nut runner body B, there was a problem that the genuine tightening force cannot be measured accurately, because the tightening force measured by the torque transducer TM inevitably includes the resistance, etc. of the power transmission mechanism for transmitting the turning force of the drive source M to the output shaft 2, to be concrete, the bevel gear mechanism BG.

### DISCLOSURE OF THE INVENTION

### Problems to be Solved by the Invention

The objective of the present invention is to provide, in view of the problem of the above-described conventional angle nut runner, an angle nut runner capable of accurately measuring the genuine tightening force.

### Means for Solving the Problem

To achieve the above-mentioned objective, the angle nut runner according to the present invention is an angle nut runner having an output shaft pivotally supported approximately perpendicular to the rotating shaft of the drive source, characterized in that a strain measuring mechanism for measuring a strain generated in the output shaft is disposed on the output shaft.

In this case, a spur gear may be disposed on the output shaft, as a power transmission mechanism for transmitting the turning force of the drive source to the output shaft.

### ADVANTAGES OF THE INVENTION

According to the angle nut runner of the present invention, which is an angle nut runner having an output shaft pivotally supported approximately perpendicular to the rotating shaft of the drive source, wherein a strain measuring mechanism for measuring a strain generated in the output shaft is disposed on said output shaft, it becomes possible to accurately measure the genuine tightening force not including any resistance, etc. of the power transmission mechanism for transmitting the turning force of the drive source to the output shaft.

Moreover, by disposing a spur gear on the output shaft, as a power transmission mechanism for transmitting the turning force of the drive source to the output shaft, it becomes possible to realize the portion near the output shaft of the angle nut runner in compact shape, and dispose the strain measuring mechanism for measuring a strain generated in the output shaft without increasing the shape of the portion near the output shaft.

### BRIEF DESCRIPTION OF THE DRAWINGS

FIG. 1 indicates an embodiment of the angle nut runner according to the present invention, (a) being a front sectional view, and (b) a sectional view A-A of (a).

FIG. 2 indicates a modified embodiment of the angle nut runner according to the present invention, (a) being a front sectional view of main part, and (b) a front sectional view of the attachment.

FIG. 3 is a front sectional view showing a conventional angle nut runner.

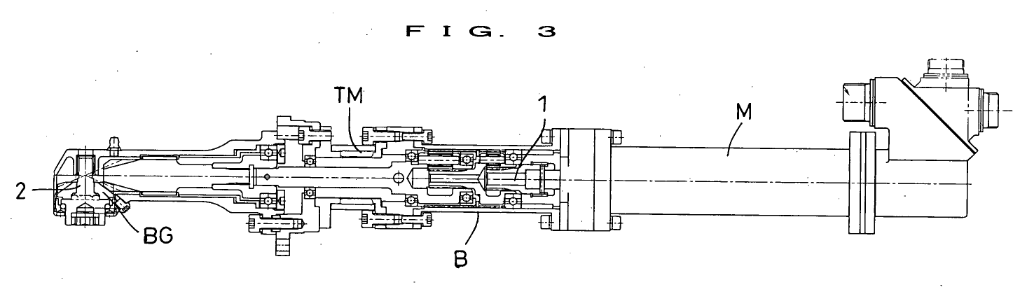

### DESCRIPTION OF REFERENCE NUMERALS AND SIGNS

B: Nut runner body
G: Strain gauge
1: Rotating shaft
2: Output shaft
21: Attachment
22: Attachment
3: Strain measuring mechanism
31: Slip ring
32: Brush
33: Internal gear
4: Power transmission mechanism
41: Bevel gear mechanism
42: Spur gear mechanism
43: Spur gear

### PREFERRED EMBODIMENT OF THE INVENTION

An embodiment of the angle nut runner according to the present invention will be explained below, with reference to drawings.

### Embodiment 1

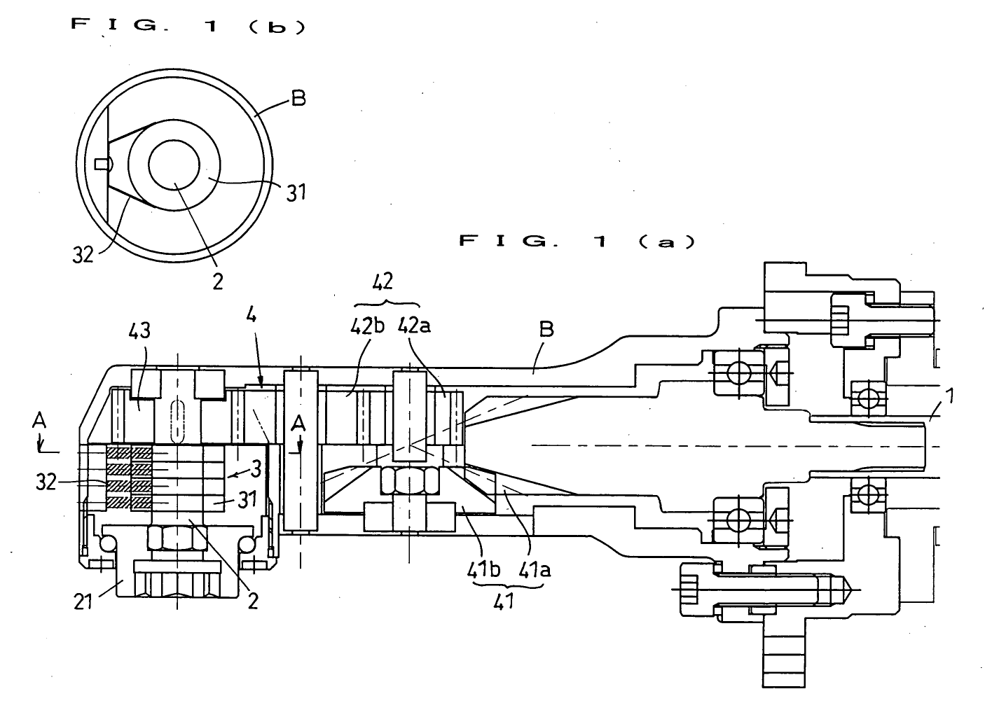

FIG. 1 indicates an embodiment of the angle nut runner according to the present invention.

This angle nut runner is an angle nut runner having an output shaft 2 pivotally supported approximately perpendicular to the rotating shaft 1 of the drive source such as electric motor, air motor, etc. (not illustrated), wherein a strain measuring mechanism 3 for measuring a strain generated in the output shaft 2 is disposed on the output shaft 2.

In this case, a bevel gear mechanism 41 composed of bevel gears 41a, 41b is disposed, in the nut runner body B, as power transmission mechanism 4 for transmitting the turning force of the drive source to the output shaft 2, so as to convert the turning force of the drive source into a turning force centering around the rotating shaft 1 of the bevel gears 41b parallel to the output shaft 2, and further transmit this turning force, through a spur gear mechanism 42 composed of spur gears 42a, 42b disposed in the nut runner body B, to a spur gear 43 disposed on the output shaft 2, to rotatively drive the output shaft 2.

As described above, by disposing a spur gear 43 on the output shaft 2, as power transmission mechanism 4 for transmitting the turning force of the drive source to the output shaft 2, it becomes possible to realize the portion near the output shaft 2 of the angle nut runner in compact shape, and dispose the strain measuring mechanism 3 for measuring a strain generated in the output shaft 2 without increasing the shape of the portion near the output shaft 2 which is often inserted in a narrow place.

The strain measuring mechanism 3 for measuring a strain generated in the output shaft 2 is disposed on the output shaft 2 on the tip side from the spur gear 43 as power transmission mechanism 4 disposed on the output shaft 2.

This strain measuring mechanism 3, not particularly restricted in system if only it can measure the strain generated in the output shaft 2, is so designed, in this embodiment, that the output of the strain gauge (not illustrated) pasted on the output shaft 2 is taken out through a snap ring 31 disposed on the output shaft 2 side and a brush 32 disposed on the nut runner body B side.

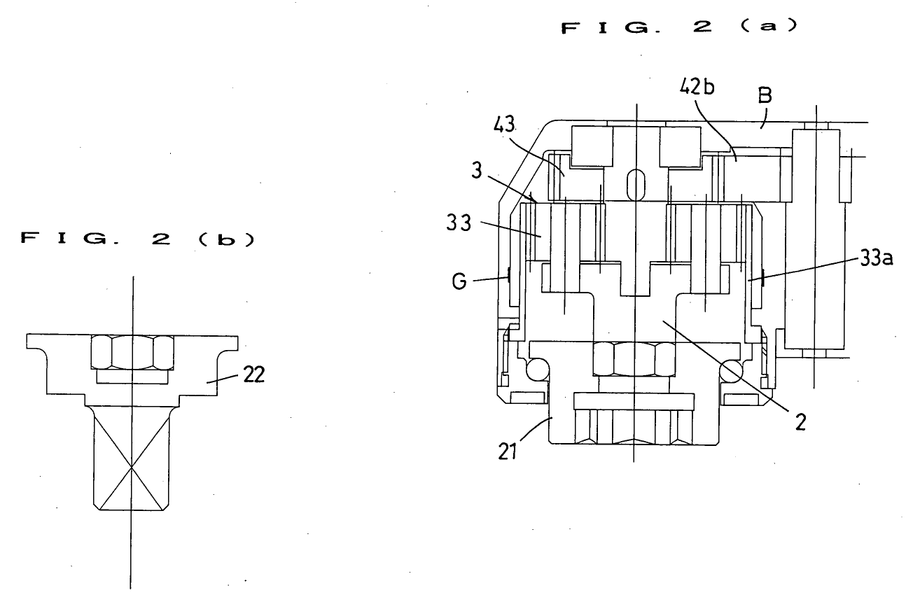

For the strain measuring mechanism 3, in addition to the above-described system of directly pasting a strain gauge on the output shaft 2, other optional system may also be adopted, such as a system of disposing an internal gear 33 engaged with the output shaft 2, and pasting a strain gauge G on the outer cylinder 33a of the internal gear 33 fixed on the nut runner body B side, as the modified embodiment indicated in FIG. 2, and a magnetic strain system of forming a magnetic strain portion on the outer circumferential face of the output shaft 2, and fixing a magnetizing-detecting coil on the nut runner body B side on the outer circumferential face of this magnetic strain portion, etc.

Furthermore, although the output shaft 2 can be formed in a shape enabling to directly operating bolts & nuts and screws, attachments 21, 22 constructed with separate body are mounted on the output shaft 2, as shown in FIG. 1 and FIG. 2, in this embodiment.

This makes it possible to cope with a variety of bolts & nuts and screws, and facilitate execution of the maintenance work.

So far, the angle nut runner according to the present invention has been explained based on its embodiment, but the present invention is not restricted to the construction described in the embodiment given above, and may be changed in construction as required within a range not deviating from its purpose.

### INDUSTRIAL APPLICABILITY

As explained above, the angle nut runner according to the present invention, which can measure the genuine tightening force be accurately, can be used suitably for applications requiring accurate measurement of tightening force, such as a manufacturing plant adopting a production control system which consists in automatically measuring-recording the number of tightened pieces and tightening force of bolts & nuts and screws, and feeding back the results of measurement in real time to the production of industrial products, etc.

1. An angle nut runner having an output shaft pivotally supported approximately perpendicular to the rotating shaft of the drive source, characterized in that a strain measuring mechanism for measuring a strain generated in the output shaft is disposed on said output shaft.

2. An angle nut runner as defined in claim 1, wherein a spur gear is disposed on the output shaft, as a power transmission mechanism for transmitting the turning force of the drive source to the output shaft.
